(19) United States
(12) Patent Application Publication
(10) Pub. No.: US 2016/0361686 A1
(43) Pub. Date: Dec. 15, 2016

(54) SELECTIVE CATALYTIC REDUCTION (SCR) DE-NOX EQUIPMENT FOR REMOVING VISIBLE EMISSION

(71) Applicant: GEESCO CO., LTD., Yongin-si (KR)

(72) Inventors: Seung Kyu JUNG, Seongnam-si (KR); Dae Woo KIM, Incheon (KR); Tae-Hee LEE, Incheon (KR)

(21) Appl. No.: 15/120,962

(22) PCT Filed: Feb. 24, 2015
(86) PCT No.: PCT/KR2015/001776

§ 371 Date: Aug. 23, 2016

(30) Foreign Application Priority Data
Feb. 26, 2014 (KR) 10-2014-0022409

(51) Int. Cl. B01D 53/86; B01D 53/94

(52) U.S. Cl. CPC B01D 53/8631; B01D 53/9431; B01D 53/864; B01D 53/944

(57) ABSTRACT

The present invention relates to a selective catalytic reduction denitrification equipment for efficiently removing visible emission (yellow plume; yellow fume) by using Selective Catalytic Reduction in order to remove the yellow fume during starting-up a gas turbine in a combined heat power or the like. To this end, a reductant supply condition is improved in an existing nitrogen oxide reduction apparatus, which uses a selective catalytic reduction method, and a ratio of NO₂/NOₓ is precisely adjusted, thereby creating an excellent effect of removal of yellow fume from exhaust gas at a low temperature of 130° C. or lower.

### TECHNICAL FIELD

The invention relates to a denitrification equipment for effectively removing visible emission (yellow plume or yellow fume) which is generated upon starting up a gas turbine from the low temperature exhaust gas of less than or equal to 130° C. by Selective Catalytic Reduction (SCR).

### BACKGROUND ART

Nitrogen oxide (NOₓ) emitted from a power station boiler, a gas turbine, an industrial boiler, an incinerator, a diesel engine, or the like is a major cause of pollution. A low NOₓ burner, Selective Non Catalytic Reduction, or Selective Catalytic Reduction has been used as a method of preventing or reducing nitrogen oxide.

Among them, the selective catalytic reduction is a method to convert nitrogen oxide contained in exhaust gas into nitrogen and water, which are harmless substances, through the following chemical equation, by spraying ammonia or urea at a front end of a denitrification catalyst such that nitrogen oxide passes through the catalyst with ammonia.

4NO+4NH₃+O₂→4N₂+6H₂O

The above reaction is referred to as the standard selective catalytic reduction (SCR) and is also known to exhibit the highest reaction efficiency at a reaction temperature of approximately 300° C. to 400° C. Hence, a combined heat power plant has been driven to achieve optimum denitrification efficiency by mounting the catalyst in a section of 300° C. to 400° C. within a heat recovery boiler to remove NOₓ generated in a gas turbine.

The optimum reaction temperature of the denitrification catalyst is 300° C. to 400° C. but it could not be achieved at the initial start-up of the gas turbine. In general, since the temperature of exhaust gas is low i.e., less than or equal to 200° C. at the initial start-up of the gas turbine in the combined heat power plant, a mess of NO₂ is emitted at the initial start-up so visible emission is generated. Due to the low temperature of exhaust gas, the reaction rate between NO₂ and NH₃ in the following formula is very slowed down.

2NO₂+4NH₃+O₂→3N₂+6H₂O

When the temperature of exhaust gas is low, it could be considered to increase the amount of the catalyst in order to improve the denitrification efficiency. However, there are technological limitations that the needed amount of the catalyst for denitrification rapidly increases as the temperature decreases. In addition, the increase of the amount of the denitrification catalyst causes the increase of pressure loss in the gas turbine thereby the efficiency of the gas turbine is rapidly decreased. A big loss of pressure can cause an unexpected stoppage of the gas turbine.

Recently, it has been conducting a removal of visible emission by spraying exhaust with ethanol or the like in order to remove NO₂ which is causative of visible emission in various combined heat powers fields. However, NO₂ could not fundamentally remove through such method and rather formaldehyde is additionally generated thereby environmental pollution is further increased.

According to recent studies, it has been reported that a fast SCR reaction, that the denitrification efficiency increases under the same amount of the catalyst as the concentration of NO₂ in exhaust gas increases; and the denitrification efficiency is maximized as a ratio of NO₂/NOₓ approaches to 0.5, is occurred at the low temperature of less than or equal to 300° C.

2NO+2NO₂+4NH₃→4N₂+6H₂O

It is known that a reaction rate of the fast SCR is 10-folds as fast as the standard SCR at a temperate of less than or equal to 200° C.

Korean patent No. 10-1057342 assigned by Geesco Co., LTD., discloses a method for effectively removing visible emission and NOₓ by using the fast SCR at a temperature lower than a reaction temperature of a general SCR. However, the present inventors identified that the amount of NOₓ generated at the outlet of the gas turbine has been decreased a lot but visible emission has been still generated a lot, according to the analyzed result of driving the gas turbine which has been diffused lately.

The present inventors analyzed the reason and found that the total amount of NOₓ could be greatly decreased by lowering the combustion temperature of a gas turbine burner and driving it in order to decrease emission quantity as much as possible, but visible emission did not remove well because, as shown in FIG. 1, the temperature of exhaust gas was too low at the start-up of the gas turbine so the temperature of exhaust gas at a rear end of the heat recovery boiler was decreased to about 130° C.

In detail, the fast SCR conditions were improved because the total amount of NOₓ was decreased thereby the ratio of NO₂/NOₓ was close to 0.5 compared to before. However, the existing reduction supplier could not sufficiently supply the need NH₃ for the catalyst reaction because the temperature of exhaust gas was decreased too much. Hence, visible emission did not remove well.

In general, NH₃ which is a reductant necessary to the catalyst reaction is supplied as ammonia gas or by heating ammonia aqueous solution or urea aqueous solution so as to be vaporized. The heating is performed by using high-temperature exhaust gas or auxiliary steam of the heat recovery boiler as shown in FIG. 2.

Korean patent No. 10-1312994 discloses that a minimum vaporizing temperature of ammonia aqueous solution used as a reductant is 200° C. to 250° C., a minimum vaporizing temperature of urea aqueous solution is 280° C. to 300° C., and a method for vaporizing a reductant using the high-temperature exhaust gas and the low-temperature exhaust gas of a heat recovery boiler. However, since it takes at least 30 minutes to 1 hour to supply the reductant to a catalyst layer by using exhaust gas or auxiliary stream after starting-up the gas turbine, it is very difficult to remove visible emission which is intensively generated within 30 minutes after starting-up the gas turbine, by the method according to Korean patent No. 10-1312994.

### REFERENCES OF THE RELATED ART

### Patent Document 1

Korean patent No. 10-1312994

### DISCLOSURE

### Technical Problem

As described above, the present disclosure provides a selective catalytic reduction (SCR) de-NOₓ equipment capable of allowing a reductant to effectively reach to a catalyst layer upon the start-up of a gas turbine in order to effectively remove visible emission generated at near the low temperature (130° C.).

Further, the present disclosure provides a selective catalytic reduction (SCR) de-NOₓ equipment in which an auxiliary heater is installed at a front of a reductant vaporizer and an oxidation catalyst and a plasma generator, an ozone generator or an oxidant sprayer are installed within the denitrification equipment, in order to effectively remove visible emission, CO and volatile organic compound (VOC) generated at near the low temperature (130° C.), and overcome the limitation of the amount of a catalyst and pressure loss.

### Technical Solution

In one aspect of the present invention to accomplish the above purpose, the following selective catalytic reduction (SCR) denitrification equipment is provided: A selective catalytic reduction (SCR) denitrification equipment including a heat recovery boiler and a reductant supplier, wherein The heat recovery boiler includes a denitrification catalyst and a nozzle unit installed at a front end of the denitrification catalyst, and wherein the reductant supplier includes a reductant storage tank and a vaporizer which is connected to the reductant storage tank and vaporizes a reductant supplied from the reductant storage tank and then transfers the vaporized reductant to the nozzle unit.

The selective catalytic reduction (SCR) denitrification equipment may include an auxiliary heater disposed at a front end of the vaporizer.

As shown in FIG. 3, the auxiliary heater is operated at the start-up of the gas turbine and sufficiently supplies the reductant to the catalyst layer. Herein, the heating may be performed by electric burner, petroleum burner or gas burner manner. When the output of the gas turbine is normalized, the auxiliary heater stops and the reductant is vaporized with the high-temperature exhaust gas or auxiliary steam, thereby energy consumption is reduced.

Furthermore, the selective catalytic reduction (SCR) denitrification equipment according to the present invention may further include an oxidation catalyst installed at a front end of the nozzle unit in order to adjust a ratio of NO₂/NOₓ.

In addition, the selective catalytic reduction (SCR) denitrification equipment according to the present invention may further include a plasma generator, an ozone generator or an oxidant sprayer installed at a front end of the nozzle unit in order to adjust a ratio of NO₂/NOₓ.

Furthermore, the selective catalytic reduction (SCR) denitrification equipment according to the present invention may further include an oxidation catalyst installed at a front end of the nozzle unit in order to adjust a ratio of NO₂/NOₓ, and a plasma generator, an ozone generator or an oxidant sprayer could be installed between the oxidation catalyst and the nozzle unit.

Furthermore, the selective catalytic reduction (SCR) denitrification equipment according to the present invention may further include an oxidation catalyst installed at a front end of the nozzle unit in order to adjust a ratio of NO₂/NOₓ, and a plasma generator, an ozone generator or an oxidant sprayer could be mounted at a front end of the nozzle unit.

Furthermore, the selective catalytic reduction (SCR) denitrification equipment according to the present invention is characterized in that the ratio of NO₂/NOₓ is 0.1 to 0.5. Preferably, the ratio of NO₂/NOₓ may be 0.15 to 0.5. Further preferably, the ratio of NO₂/NOₓ may be 0.2 to 0.5.

### Advantageous Effects

As apparent from the above description, in accordance with the present invention, the amount of catalyst is properly adjusted within the allowable range of pressure loss of the gas turbine and the ratio of NO₂/NOₓ is adjusted to approach to 0.5, in order to remove visible emission at near 130° C. by using a selective catalytic reduction (SCR), thereby the denitrification efficiency of the catalyst at the low temperature could be maximized.

The selective catalytic reduction (SCR) denitrification (de-NOₓ) equipment according to the present invention can effectively remove visible emission, CO and VOC which are generated at the low temperature of near 130° C. by installing the auxiliary heater at the reductant supplier, or installing the oxidation catalyst or the oxidant sprayer at the heat recovery boiler. Furthermore, ultimately, the denitrification equipment which minimize the generation of nitrogen oxide may be widely used in various fields such as a power station boiler, a gas turbine, an industrial boiler, a furnace, a diesel engine, and so on.

### DESCRIPTION OF DRAWINGS

FIG. 1 shows a graph that the temperature of exhaust at a rear end of a superheater of a heat recovery boiler in a rear end of a gas turbine fluctuates with an output of a gas turbine.

FIG. 2 shows a combined heat power SCR equipment including a conventional reductant supplier;

FIG. 3 shows a combined heat power SCR equipment including an auxiliary heater installed to a reductant supplier;

FIG. 4 shows a combined heat power SCR equipment including an auxiliary heater installed to a reductant supplier and an oxidation catalyst installed in a heat recovery boiler;

FIG. 5 shows a combined heat power SCR equipment including an auxiliary heater installed to a reductant supplier and a plasma generator, an ozone generator or an oxidant sprayer installed at a front end of a denitrification catalyst in a heat recovery boiler;

FIG. 6 shows a combined heat power SCR equipment including an auxiliary heater installed to a reductant supplier, an oxidation catalyst installed in a heat recovery boiler, and a plasma generator, an ozone generator or an oxidant sprayer installed at a front end of the oxidation catalyst; and

FIG. 7 shows a combined heat power SCR equipment including an auxiliary heater installed to a reductant supplier, an oxidation catalyst installed in a heat recovery boiler, and a plasma generator, an ozone generator or an oxidant sprayer installed at a rear end of the oxidation catalyst.

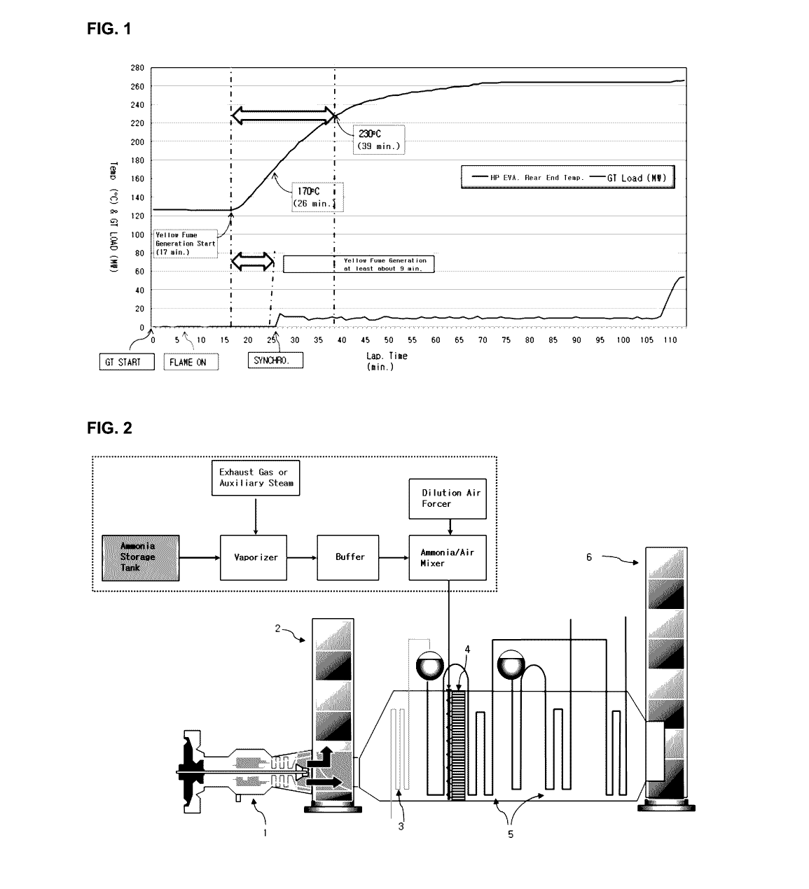

[Detailed Description of Main Elements]

| | |
|---|---|
| 1: gas turbine | 2: bypass chimney |
| 3: superheater of heat recovery boiler | 4: denitrification catalyst |
| 5: reheater of heat recovery boiler | 6: main chimney |

7: oxidation catalyst
8: plasma generator, ozone generator or oxidant sprayer

### BEST MODE

Hereinafter, the embodiments of the present disclosure will be described in detail with reference to accompanying drawings.

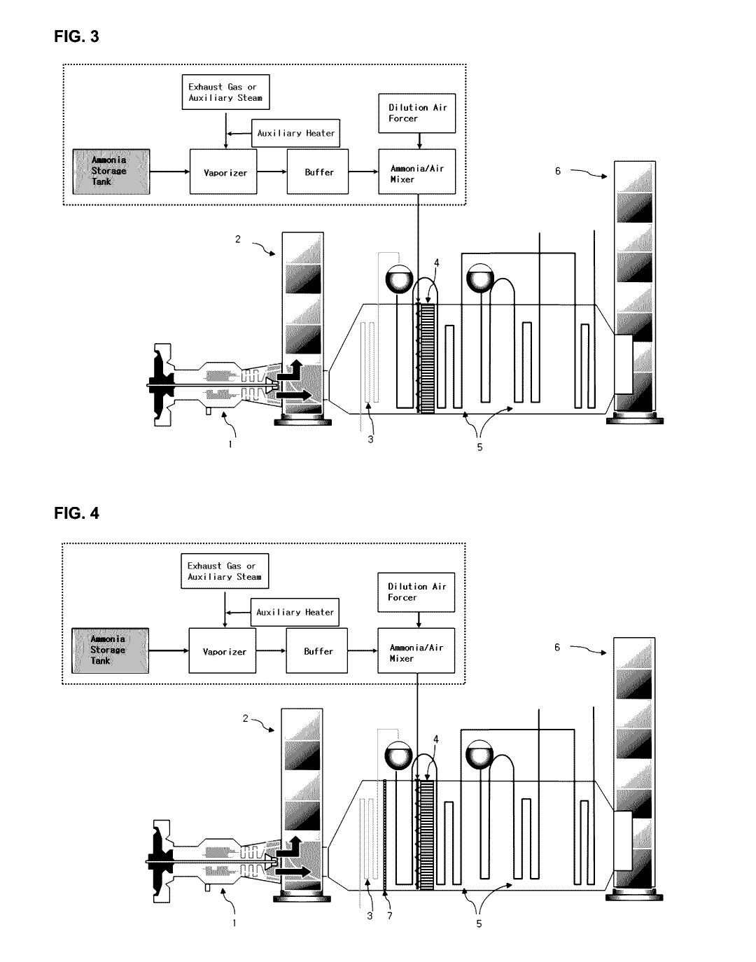

In a conventional combined power, an SCR equipment has been driven as shown in FIG. 2. Herein, a reductant vaporizer heats and vaporizes a reductant using high-temperature exhaust gas or auxiliary steam.

According to the present invention, an auxiliary heater is installed at a front end of a reductant vaporizer, as shown in FIG. 3, thereby a reductant NH₃ immediately reaches to a denitrification catalyst at the same time with the startup of a gas turbine, as a result, it is possible to effectively remove visible emission and NOₓ even at the low temperature upon starting up the gas turbine.

It is desired to vaporize a reductant NH₃ by operating an auxiliary heater, and then spray the denitrification catalyst with NH₃ at the same time with the startup of the gas turbine.

Meanwhile, the amount of the catalyst included in the SCR equipment has been provided according to a normal operating condition. Of course, a sufficient amount of the catalyst might be provided but a large amount of the catalyst causes the increase of pressure loss and the decrease of the efficiency of the gas turbine. Further if severe, an unexpected stoppage of the gas turbine may be caused. Accordingly, a minimum amount of the catalyst has been provided.

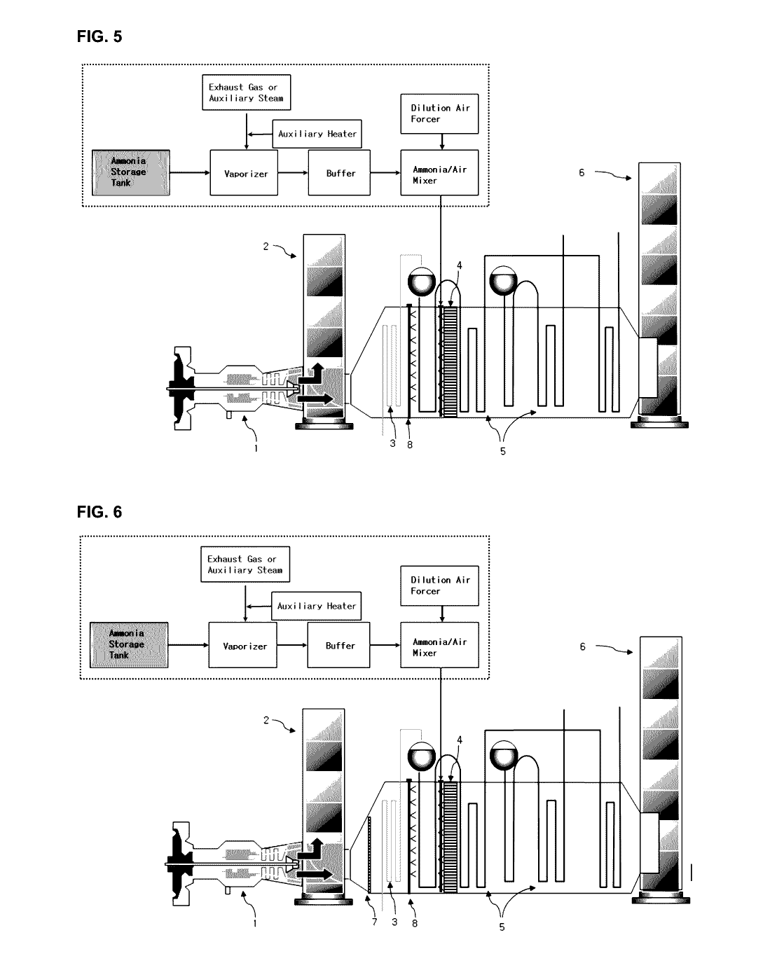

However, if a minimum amount of the catalyst is provided, it may not be enough to remove the low temperature visible emission which is generated when the gas turbine starts up. In this case, as shown in FIG. 4, if an oxidation catalyst is installed at a high-temperate area in a rear end of the gas turbine and a denitrification catalyst is installed in a heat recovery boiler, a fast SCR reaction could be occurred, thereby visible emission and NOₓ may be removed from the low temperature exhaust gas. Further, when the oxidation catalyst is installed at a rear of the gas turbine, CO and VOC which are generated during the operation of the gas turbine may be also removed.

Furthermore, as shown in FIG. 5, a plasma generator, an ozone generator or an oxidant sprayer may be installed at a front end of the heat recovery boiler. As shown in FIG. 4, when the oxidation catalyst is installed at the rear end of the gas turbine, the efficiency of the gas turbine may be decreased due to the increase of pressure loss. In this case, if the plasma generator, the ozone generator or the oxidant sprayer is installed, a ratio of NO₂/NOₓ could be minutely adjusted by spraying with plasma, ozone or oxidant when the gas turbine starts up thereby visible emission or the like may be easily removed.

Preferably, the oxidation catalyst; and the plasma generator, the ozone generator or the oxidant sprayer may be installed in the denitrification equipment according to the present invention, in order to remove visible emission, CO or VOC while to minimize pressure loss of the gas turbine.

More preferably, in the denitrification equipment according to the present invention, the auxiliary heater may be installed at the vaporizer in order to remove visible emission generated at the initial operation, the oxidation catalyst may be installed to occur the fast SCR, and further the plasma generator, the ozone generator or the oxidant sprayer may be installed in order to compensate pressure loss.

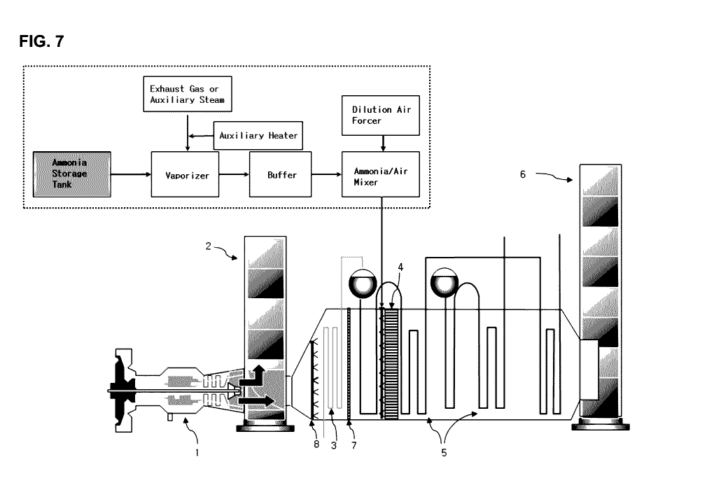

The oxidation catalyst may be installed at a front end of a nozzle unit of the denitrification equipment, and the plasma generator, the ozone generator or the oxidant sprayer may be installed between the oxidation catalyst and the nozzle unit (see FIG. 6). Alternatively, the oxidation catalyst may be installed at a front end of the nozzle unit of the denitrification equipment, and the plasma generator, the ozone generator or the oxidant sprayer may be installed at a front end of the oxidation catalyst (see FIG. 7).

In aspect, FIG. 6 shows a schematic diagram illustrating a system capable of maximizing efficiency of denitrification at the low temperature and removing NO₂ as visible emission. In detail, NO is oxidized to NO₂ with the oxidation catalyst. To replenish deficiency of NO₂, NO is oxidized to NO₂ with the insertion of an oxidant such as ozone or peroxide. The appropriate amount of NO₂, as generated, passes through the denitrification catalyst. As a result, the ratio of NO₂/NOₓ approaches to 0.5 which is appropriate to remove visible emission at the low temperature upon starting-up the gas turbine.

In the case of FIG. 6, if the temperature of exhaust gas decreases, the reaction efficiency of the oxidation catalyst may be rapidly decreased and thus it may be difficult to remove visible emission. In this case, as another aspect, as shown in FIG. 7, if NO₂ passes through the oxidation catalyst after NO is oxidized to NO₂ with the oxidant such as ozone, the reaction temperature of the oxidation catalyst may be decreased from 300° C.-350° C. to 120° C.-200° C. As a result, the denitrification efficiency may be maximized at the low temperature of exhaust gas and NO₂ as visible emission may be removed.

### MODE FOR DISCLOSURE

Various embodiments have been described in the best mode for carrying out the disclosure.

1. A selective catalytic reduction denitrification equipment comprising a heat recovery boiler and a reductant supplier,
wherein the heat recovery boiler comprises a denitrification catalyst and a nozzle unit installed at a front end of the denitrification catalyst, and the reductant supplier comprises a reductant storage tank and a vaporizer which is connected to the reductant storage tank, vaporize a reductant supplied from the reductant storage tank and transfer the vaporized reductant to the nozzle unit; and
wherein an auxiliary heater is provided at a front of the vaporizer.

2. The selective catalytic reduction denitrification equipment according to claim 1, wherein an oxidation catalyst is installed at a front end of the nozzle unit to adjust a ratio of NO₂/NOₓ.

3. The selective catalytic reduction denitrification equipment according to claim 1, wherein a plasma generator or an oxidant sprayer is installed at a front end of the nozzle unit to adjust a ratio of NO₂/NOₓ.

4. The selective catalytic reduction denitrification equipment according to claim 1, wherein an oxidation catalyst is installed at a front end of the nozzle unit and a plasma generator or an oxidant sprayer is installed between the oxidation catalyst and the nozzle unit, in order to adjust a ratio of NO₂/NOₓ.

5. The selective catalytic reduction denitrification equipment according to claim 1, wherein an oxidation catalyst is installed at a front end of the nozzle unit and a plasma generator or an oxidant sprayer is installed at a front end of the oxidation catalyst, in order to adjust a ratio of NO₂/NOₓ.

6. The selective catalytic reduction denitrification equipment according to claim 3 or 4, wherein the rate of NO₂/NOₓ is 0.1 to 0.5.
